(19) United States
(12) Patent Application Publication
(10) Pub. No.: US 2021/0378181 A1
(43) Pub. Date: Dec. 9, 2021

(54) HARVESTING DEVICE WITH AUTOMATED IRIS

(71) Applicant: ETEROS TECHNOLOGIES USA, INC., Surrey (CA)

(72) Inventors: Dana Mosman, Boulder, CO (US); Donald Mosman, Nevada City, CA (US); Ángel Ramon Torrado Perez, San Diego, CA (US)

(21) Appl. No.: 17/335,494

(22) Filed: Jun. 1, 2021

Related U.S. Application Data
(60) Provisional application No. 63/034,080, filed on Jun. 3, 2020.

(51) Int. Cl. A01G 3/08

(52) U.S. Cl. CPC A01G 3/085; A01G 2003/005

(57) ABSTRACT

The present invention shows an apparatus for trimming plants, specifically assisting with the process of separating leaves and buds from the stem and branches of the plant. The apparatus is composed by an iris mechanism with blades that automatically close around a plant stem when the plant stem is inserted into the apparatus. In a further arrangement, the iris mechanism automatically opens once the plant stem has been processed.

### CROSS REFERENCE

The present application claims the benefit of U.S. Provisional Application No. 63/034,080 having a filing date of Jun. 3, 2021, the entire contents of which is incorporated herein by reference.

### FIELD

The present disclosure is directed to the trimming of plants, and in particular to an automatically engaging iris mechanism for removing of material such a leaves, buds and flowers from a stem portion of a plant.

### BACKGROUND

Flowers, buds and leaves harvested from stemmed plants are often used in oils, medicinal products, aromatherapy, cuisine, perfumes, dyes, oils, toilet preparations, tinctures, distillation products (steam distillation of lavender oil), and the like. Such stemmed plants are sometimes cut at the base of the stem (e.g., trunk, stalk, etc.) in the field and transported to a location for processing.

Commonly, such processing requires numerous workers who manually strip useful portions of the plant (leaves, buds, etc.) from the generally less useful stem portion(s). This processing is often labor intensive, repetitive and time-consuming. Accordingly, there is a need in the art for a method and mechanical apparatus for separating buds and leaves from the stem and/or branches of stemmed plants that reduces labor requirements.

### SUMMARY

Aspects of the presented inventions are directed to a harvesting device that strips material of a plant from a stem portion of a plant. One aspect is directed to an adjustable iris mechanism that includes a plurality of blades. More specifically, the positions of the blades are adjustable to define an opening or cutting orifice into which a stem of a plant may be inserted (e.g., a severed base of the stem/stalk). After the plant stem is inserted into or partially through the cutting orifice, the blades may automatically close or tighten around the stem. Once the blades are closed, the remainder of the stem is drawn through the iris mechanism, which draws leaves, buds, etc. (e.g., plant material) of the plant across cutting surfaces of the blades. This action removes plant material from the stem to permit subsequent use and/or processing. In one arrangement, the blades may be spring loaded such that they may be released to automatically close around a stem upon sensing the insertion of the stem through the orifice. In another arrangement, an actuator may close the blades around the stem upon sensing insertion of the stem through the orifice. In a further arrangement, the actuator may open the orifice once the stem has been processed.

In an aspect, a harvesting device for separating plant material from a stem and branches of a plant is described. The harvesting device includes an iris mechanism and a drive mechanism. The iris mechanism may comprise a plurality of blades that may be moveably attached together such that they may be opened and closed in unison. That is, the plurality of blades may be configured to form a cutting orifice that may be adjusted in size (e.g., diameter). The drive mechanism includes first and second counter rotating rollers that are driven by at least a first motor. The first and second rollers define a pinch nip that is configured to receive and engage a stem of a plant to pull the plant between the rollers and through the cutting orifice. The device may further include an orifice sensor. The sensor may be a proximity sensor (e.g., infrared, optical, etc.) configured to identify the presence of an object (e.g., plant stem) at a location within or near the harvesting device. For instance, the sensor may be configured to detect a stem positioned through the cutting orifice, positioned in front of the cutting orifice and/or positioned along the pinch nip between the rollers. Upon detecting the stem, the sensor may generate an output that causes the orifice to close around the stem. By way of example, the cutting orifice may initially be open and upon a user disposing the stem through the cutting orifice, the sensor may identify the presence of the stem and engage the plurality of blades about the stem. In an arrangement, the sensor is an optical sensor (e.g. infrared) that projects and/or receives an optical signal or generally a “beam.” Upon a plant stem breaking or otherwise disrupting the beam, the sensor generates an output that results in the iris closing. In a further arrangement, the orifice may be opened (e.g., automatically) once the stem is processed and, for example, the sensor no longer senses the presence of the stem. In a specific arrangement, upon the beam being re-established, the sensor generates an output that results in the iris opening. In another arrangement, the speed of the rollers may be controlled based on the output of the sensor. For instance, a speed a variable speed motor/drive connected to one or both of the rollers may be increased upon sensing the presence of a plant stem. The rollers may operate at a higher speed until the stem is processed. Once processed, the rollers may return to a lower speed (e.g., idle speed). In another arrangement, motor operation is monitored to determine completion of stem processing for the purpose of reopening the cutting orifice.

In another aspect, a method for removing plant material from a plant is described. The method may include receiving a stem or stalk portion of a plant in drive mechanism of a harvesting device between a pair of counter rotating nip rollers to engage the portion of the plant and pull the plant through the harvesting device. The method may further include closing a cutting iris about the stem or stalk in an automated process in conjunction with pulling the plant through the device. Upon closing around the stem or stalk, the blades of the iris mechanism cut leaves, beds, etc. from the stem or stalk as the nip rollers pull the plant through the cutting iris. Once the stem completes passage through the harvesting device, the cutting orifice may be reopened to await another stem for processing. Speed of the roller may also be controlled upon the closing of the iris mechanism around the stem or stalk.

In a further aspect, a harvesting device is provided that includes an iris mechanism and a drive mechanism. The iris mechanism may comprise a plurality of blades that may be moveably attached such that they may be opened and closed in unison. That is, the plurality of movable blades may be configured to form a cutting orifice that may be adjusted in size (e.g., diameter). Removable blade inserts or edges may be attached to the movable blades. The blade inserts may be replaced without disassembling the iris mechanism.

### BRIEF DESCRIPTION OF THE DRAWINGS

FIG. 1 illustrates a perspective view of an embodiment of a harvesting device in accordance with the present disclosure.

FIGS. 2A and 2B illustrate a side and side cross-sectional view of the harvesting device.

FIGS. 3A and 3B illustrates an iris mechanism of the harvesting device.

FIG. 4 illustrates an actuator mechanism for opening and closing the iris mechanism.

FIG. 5 illustrates two perspective mirror views of the harvesting device.

FIG. 6 illustrates an embodiment of a proximity sensor.

FIG. 7 illustrates a partial side cross-sectional view of the sensor mounted relative to drive rollers and the iris mechanism of the device.

FIG. 8 illustrates a process that may be implemented by a controller associated with the harvesting device.

FIGS. 9A-9C illustrate opening and closing the iris mechanism based on sensing the presence and absence of a plant stem.

FIG. 10 illustrate an exemplary simplified graph of monitoring a motor amperage for detecting passage of a plant stem through the harvesting device.

FIGS. 11A and 11B illustrates removable blade edges or inserts that are connectable to movable blades of the iris mechanism.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

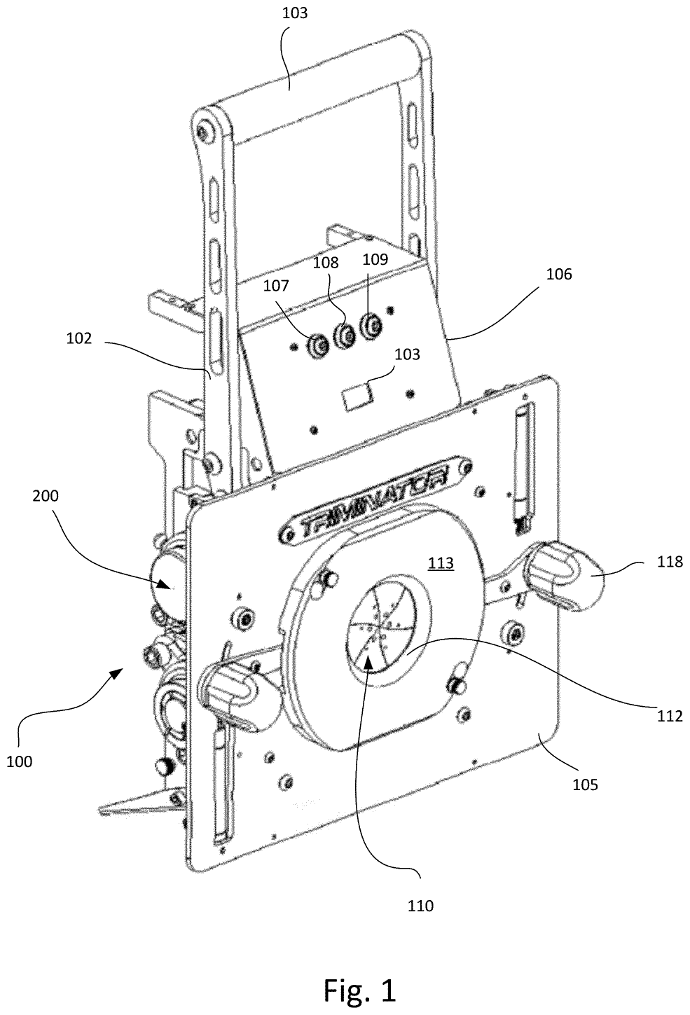

The presented device is directed to removing plant material (e.g., buds, leaves, etc.) from the stem and/or branches of a plant. FIG. 1 provides a front perspective view of a harvesting device 100 composed of two major assemblies: an iris mechanism 110 and a drive mechanism 200. The iris mechanism 110 and drive mechanism are each connected to a supporting frame 102. The frame 102 may be constructed of any appropriate material(s) such as aluminum, steel, hard plastic, etc. and may be configured to at least partially shield users from debris and moving parts. A front plate 105 of the iris mechanism 110 may at least partially enclose moving parts of the drive mechanism 200 within the frame 102. The front plate 105 may be constructed from a hard material such as steel or aluminum to resist damage from repeated impact and scraping from branches, stems, etc. The device may include a handle 103 and/or stand (not shown) to assist in transporting and positioning the harvesting device 100.

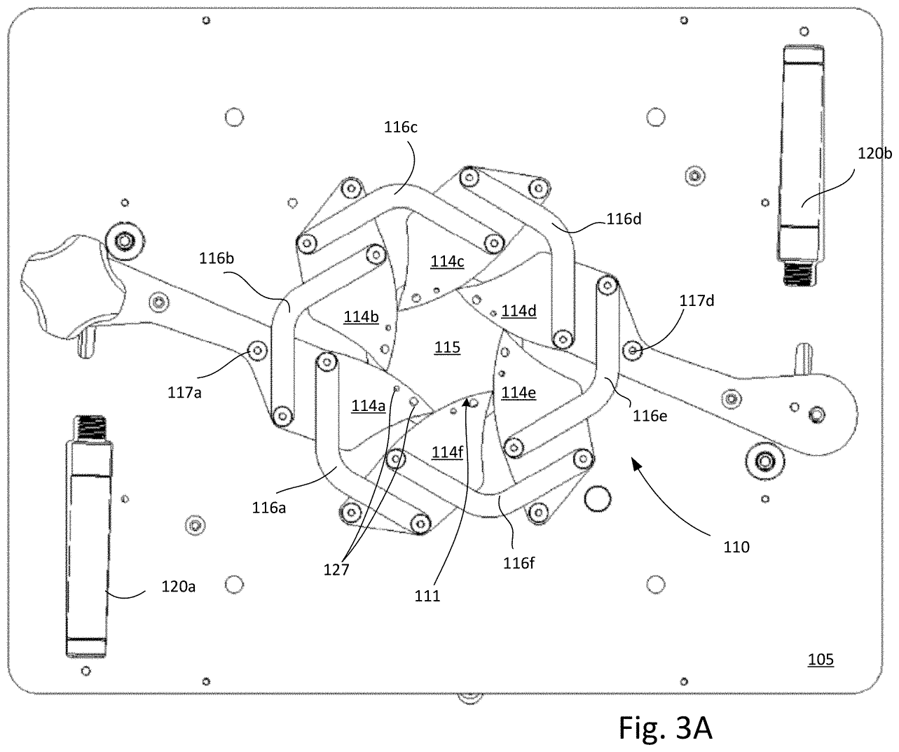

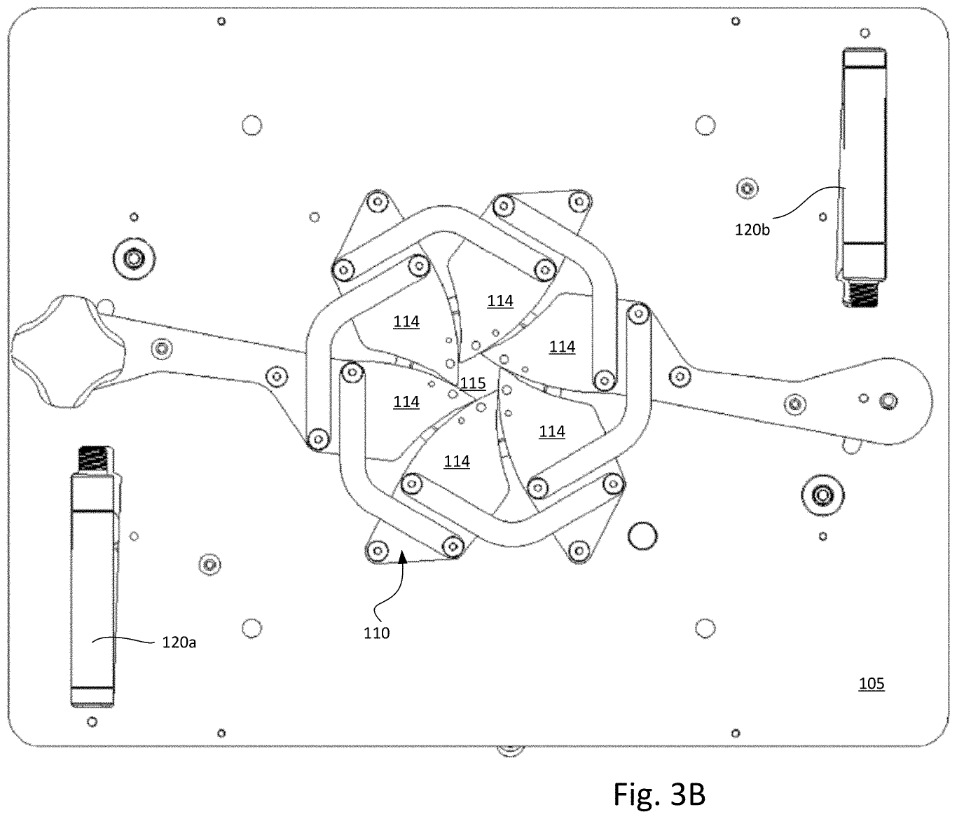

The iris mechanism 110 is utilized to separate plant material (e.g., buds and leaves) from the stem and branches of a plant, assisted by the pulling force generated by the drive mechanism 200. A user may manually feed a portion of a plant (e.g., the cut end of a stem of a harvested plant) through an opening 112 in the front plate 105 and through a cutting orifice formed by multiple blades of the iris mechanism 110, as is further discussed herein. During use, the drive mechanism 200 may engage a stalk or stem (hereafter stem) of a plant disposed through the opening 112 (e.g., while the blades 114 of the iris mechanism 110 are open; see FIG. 3A) and draw it through the iris mechanism 110 (e.g., while the blades 114 of the iris mechanism are closed around the stem; see, e.g., FIG. 3B). The blades 114 of the iris mechanism 110 may scrape the sides of the stem and any protruding branches, thereby dislodging desirable portions of the plant (i.e., plant material) which may fall, for example, into a collection bin. In the illustrated embodiment, an optional guide plate 113, having a conical opening may assist the user in guiding an end of a plant into the opening 112 and cutting orifice and may also assist in folding protrusions (e.g., branches) toward the stem of a plant.

The harvesting device 100 may also include a controller 106 having any number of operational control and feedback devices. The controller may include a microprocessor, non-volatile memory, supported logic and various input and output ports for operative connection to sensors and actuators. The controller may be operatively connected to various sensors, motors and actuators as discussed herein. In addition, the controller 106 may include, without limitation, a display 103 (e.g., LCD), a power switch 107, an iris opening switch 108, and an iris closing switch 109. The display 103 may provide a user with various visual feedback including, but not limited to, current operating speed, current blade or drive roller pressure, motor temperature, total hours of use, detected anomalies or maintenance issues, battery indicator, etc. The iris opening and closing switches may be manually manipulated by a user to open and close the iris mechanism. The power switch may be any appropriate mechanism effective for powering on and off the harvesting device 100. It should be appreciated that the illustrated embodiment of controller 106 is provided for example only. Each depicted switch, button, or knob may be optional and the arrangement of controls may be altered. Other controls are possible.

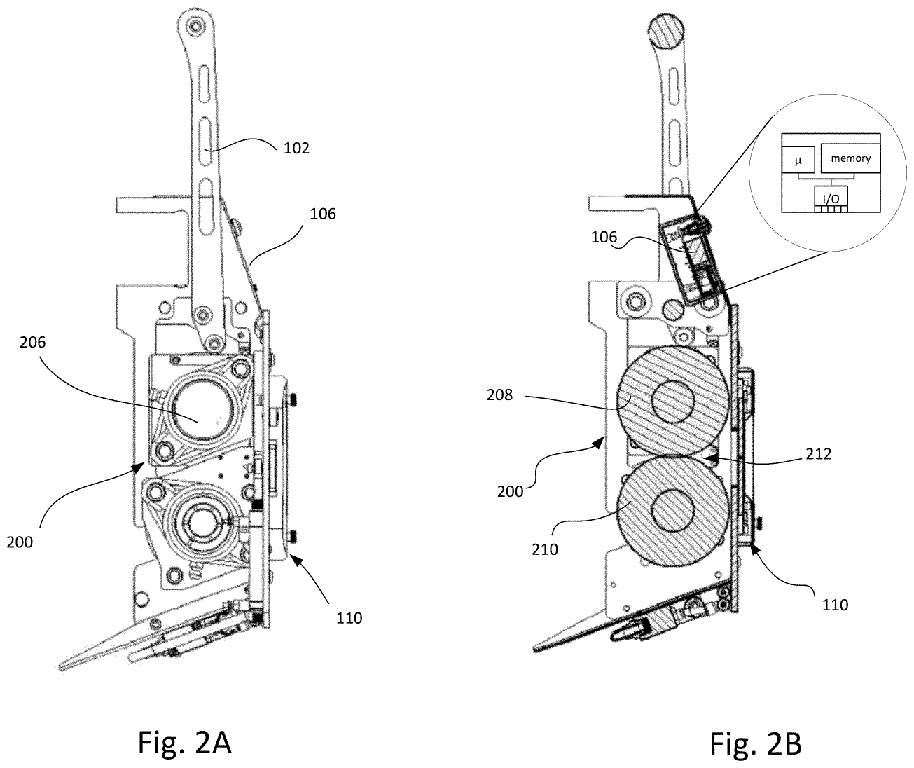

FIGS. 2A and 2B illustrate side and side cross-sectional views the harvesting device 100. As illustrated, the drive mechanism 200 is mounted to the frame on the back side of the front plate 105 and behind the iris mechanism 110. At least one drive motor 206 rotates a drive roller 208, which may engage a second roller 210. Accordingly, rotation of the first roller 208 may impart a counter rotation on the second roller 210. Alternatively, both rollers may be driven by separate motors and/or connected by appropriate gearing, chains, belts, pulleys etc. In an embodiment, the motor may be a variable speed motor. In such an embodiment, the speed of the motor 206 may be controlled to alter the speed (e.g., RPMs) of the rollers 208, 210. Collectively, the two roller 208, 210 define a pair of pinch rollers having a pinch or inlet nip 212 therebetween. When a user inserts a stem through the opening 112 of the front plate 105 and through the cutting orifice defined by the blades of the iris mechanism 110, the stem may be engaged by the drive mechanism 200. More specifically, the opening in the front plate and cutting orifice of the iris mechanism 110 may be disposed in front of the drive mechanism 200 such that, upon insertion of a plant (e.g., plant stem) through the cutting orifice, the stem engages the nip 212 defined by the mating counter rotating rollers 208, 210. The counter rotation of the rollers pulls the plant between the rollers 208, 210 and through the iris mechanism. Thus, the rollers may draw the plant through the cutting orifice and cutting surfaces defined by the blades of the iris mechanism. That is, upon engagement of the stem of a plant at the pinch nip 212 between the rollers 208, 210, complementary rotation of the drive rollers pulls the stem through the iris mechanism 110 such that the blades of the iris mechanism strip plant matter from the stem.

The rollers 208, 210 may be formed of any appropriate material. For example, plastics or polymers (e.g., natural and/or synthetic rubbers) may be used to reduce weight. Alternatively, metal such as steel may be used to increase the service life of the rollers. The contact surfaces of the rollers (e.g., the outer surface of the cylinder which engages a plant) may be configured for improved frictional engagement of plants. For example, surfaces of the rollers may be ribbed in a direction transverse to the direction of travel of an inserted plant. In this regard, the ribs may engage the plant firmly and reduce the probability of slippage. Additionally or alternatively, the drive rollers may comprise spikes, teeth, barbs, threads, and/or a grip coating.

In the illustrated embodiment, the drive roller 206 directly couples to a shaft of the drive motor 206. However, it should be appreciated that alternative configurations are envisaged. For example, a drive motor may be affixed to a gear, the teeth of which, in turn, engages with teeth of a drive roller for indirect rotation of the drive roller by the drive motor.

FIGS. 3A-3B illustrate a rearward view of the iris mechanism 110 as mounted on the back surface of the front plate 105. As shown, the iris mechanism includes a plurality of individual blades 114a-f (hereafter 114 unless specifically referenced) configured to form an adjustable diameter cutting orifice. As illustrated, the iris mechanism 110 includes six blades 114 although it is contemplated that more or fewer blades may be utilized. Each of the plurality of blades 114 has a body that is pivotally attached at its base end to the rearward surface of the front plate 105. An edge of each blade between its attached base end and its free distal tip forms a cutting edge 111. Collectively, the cutting edges of all the blades define the cutting orifice of the iris mechanism 104. Each cutting edge may be sharpened or beveled to aid in the removal of plant material. In the illustrated embodiment, each blade 114 is pivotally attached to its two neighboring or adjacent blades by a translation link 116a-f (hereafter translation link 116 unless specifically referenced). More specifically, each end of each translation link 116 is pivotally attached to two adjacent blades 114. Once all the blades 114 are connected, the blades move in unison to open and close (e.g., adjust) the cutting orifice 115. Other connections for the blades of the iris mechanism are possible.

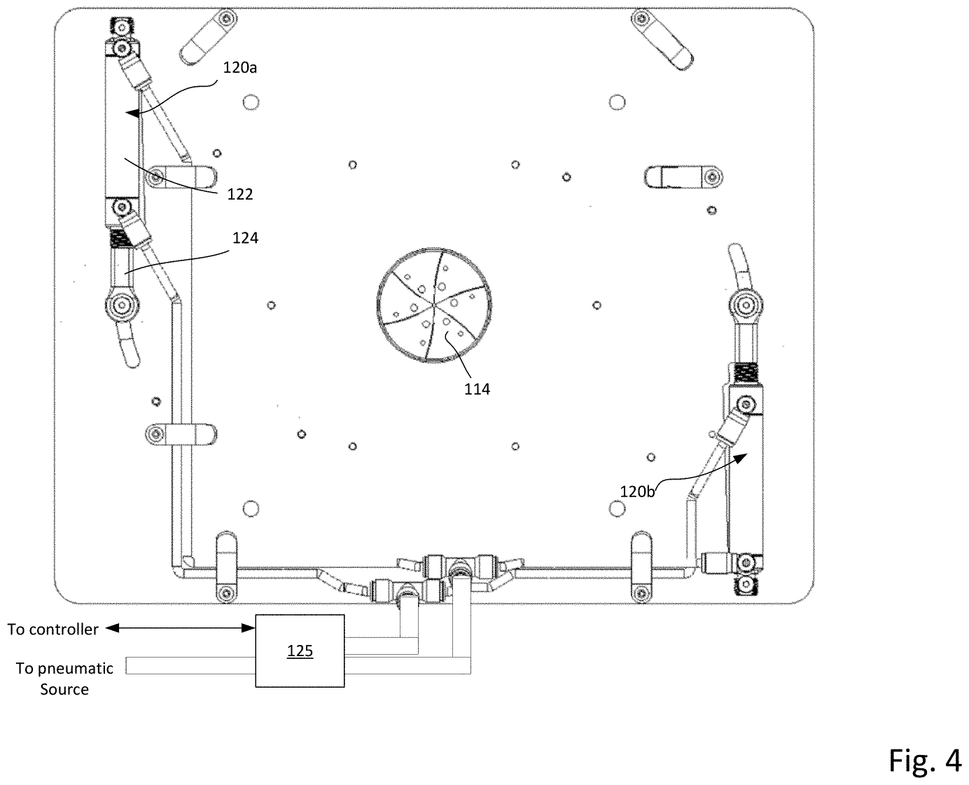

The blades 114 may be actuated by any actuating means. In the illustrated embodiment, two of the blades 114a and 114d are elongated blades having rearward end portions that pivot about pivotal connections 117a, 117d, respectively. Applying force to the rearward end portions of the elongated blades allows for opening or closing the cutting orifice. A manual means for adjusting the cutting orifice includes user handles 118 that connect to the rearward ends of the elongated blades. These user handles 118 are fixedly attached to the rearward end via a bolt or shaft (not shown) that extends through an elongated opening in the face plate 105. The handles 118 allow a user to physically adjust the cutting orifice. In the illustrated embodiment, another actuating means includes linear actuators 120a, 120b (hereafter 120 unless specifically referenced). As best illustrated in FIG. 4, the linear actuators 120 are each configured to engage the rearward end of one of the elongated blades 114a, 114d. As illustrated the actuators 120 are pneumatic actuators having a cylinder 122 and shaft 124. Various pneumatic fittings and tubes permit advancing and retracting the shaft 124, which connects to the rearward end of an elongated blade. As the linear actuators 120 extend their shafts, the blades may move to open the cutting orifice. Likewise, when the linear actuators retract their shafts, the blades may move to close the cutting orifice. In the illustrated embedment, the linear actuators 124 are connected to an actuator controlled pneumatic valve 125, which is connected to and controllable by the controller.

The linear actuators 120 may be controlled, for example, by depressing a button on the controller. Additionally or alternatively, a sensor may be provided for automatically closing the cutting orifice about a stem or stalk placed through the orifice when it is open. Likewise, a sensor may be provided for automatically opening the cutting orifice once a stem/stalk is fully processed. That is, an output of such a sensor may be used to control the linear actuators 120. It should be appreciated that while the device is shown as utilizing two linear pneumatic actuators, different actuators (e.g. rotary, electric, hydraulic) may be utilized.

During use, the cutting orifice of the harvesting device 100 may be open awaiting insertion of a plant stem. An end (e.g., cut end) of a plant stem may be inserted through the opening in the front plate 105 and through the open cutting orifice. The stem passes through the cutting orifice of the iris mechanism 110 and contacts one or both rollers. Passage of the stem through the open cutting orifice may be detected by one or more sensors, causing the cutting orifice to automatically close around the stem. Such automated closure of the cutting orifice greatly facilitates workflow as a user no longer needs to manually close the orifice while the nip rollers are drawing the plant through the machine. Upon the stem extending through the cutting orifice, an output of the sensor, as received by the controller, may change. Based on such an identified change, the controller may send control signals causing the cutting orifice of the iris mechanism to close around the stem. For example, upon identifying the presence of a stem, the linear actuators may be actuated (e.g., via a controllable pneumatic valve; not shown) to close the cutting orifice about the stem. In one embodiment, the actuators may extend until a predetermined force is applied to the plant stem within the orifice. After a stem passes through the counter rotating rollers, the controller may also be configured to automatically open the cutting orifice. In an embodiment, the same sensor(s) that identify the presence of the stem may be utilized to identify the absence of the stem. Upon identifying the absence of the stem (e.g., the stem has passed through the rollers) the linear actuators may be utilized to open the cutting orifice to await insertion of another plant stem. Additionally, the controller may send control signal(s) changing the rotational speed of the rollers. For example, upon identifying the presence of a stem, the controller may increase the rotational speed of the rollers by adjusting the speed of the motor (e.g., variable frequency drive or similar technology installed to control motor speed and torque). After a stem passes through the counter rotating rollers, the controller may also be configured to return the rollers to a baseline speed (e.g., idle speed).

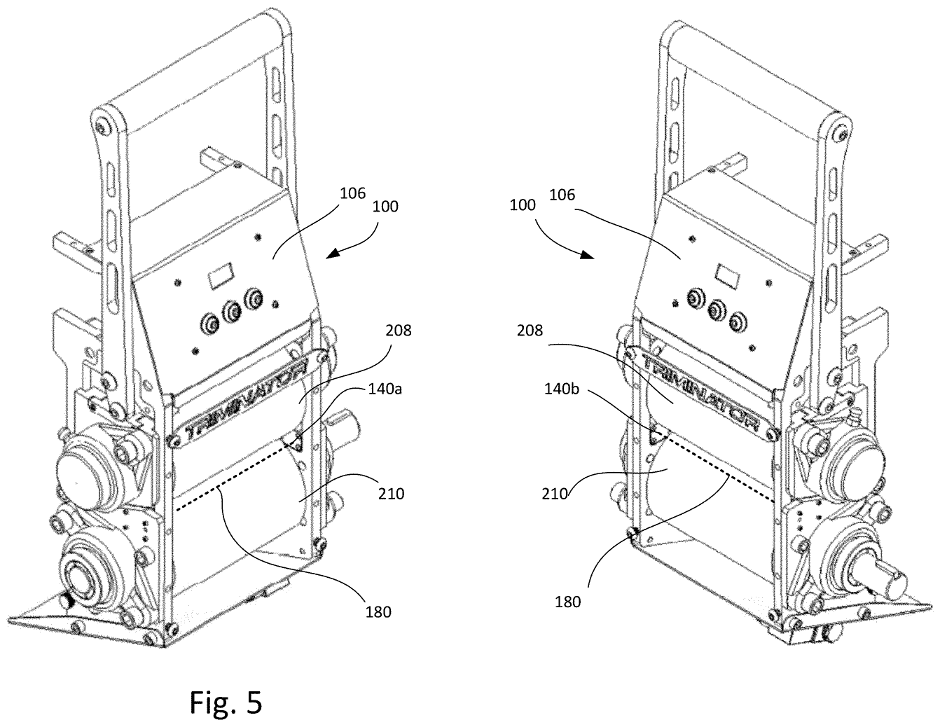

Turning to FIG. 5, two perspective views of the harvesting device 100 are shown with the front plate and iris mechanism removed. As illustrated, two sensors 140a, 140b, an emitting unit and a detecting unit, are provided for detecting the presence of a stem that is disposed proximate to the interface or nip between the rollers 208, 210. Other embodiments may utilize a single unit that both emits and detects. As illustrated, the two sensors 140a, 140b are attached to the frame of the device proximate to opposing ends of the rollers. In the illustrated embodiment, the sensors 140 are optical sensors. However, it will be appreciated that other proximity sensors may be utilized. Such proximity sensors may include, without limitation, laser sensors, ultrasonic sensors and doppler sensors to name a few. In an embodiment the sensors are photoelectric sensor elements that emit and/or receive infrared light, which is illustrated as a light beam 180 between the sensor elements. In the illustrated arrangement, one of the sensor elements 140a is an emitter and the other sensor 140b is a receiver (hereafter sensor 140 unless specifically referenced). In this arrangement the receiving sensor is located within the line-of-sight of the transmitting sensor. In one non-limiting example, the emitter is a 1te-302 infrared emitter and the detector is an 1tr-301 photo sensor, both produced by Lite-On Inc. The light 180 emitted and detected between the sensors 140 is substantially parallel to the pinch nip defined between the rollers 208, 210. Accordingly, if a stem protrudes through the open orifice to a location proximate to the pinch nip, the stem will interfere with the light 180. That is, a stem is detected when the light 180 between the receiver and the transmitter is partially or entirely blocked. That is, an intensity of the light received by the sensor may change based on the blockage of the light 180. Accordingly, when the light beam or path between the sensor elements is blocked, partially blocked or otherwise disrupted an output of the detector sensor may be altered. In one arrangement, programming is provided in the controller for receiving periodic outputs from the sensor element(s). In such an arrangement, the controller may receive outputs multiple times per second (e.g., 30-50 times per second). The controller may keep a running average of the sensor outputs for a predetermined time window or predetermined number of previous values. Such a running average may be compared to a predetermined threshold to determine if the sensors are blocked or partially blocked. Multiple variations and alternate sensing schemes are possible and considered within the scope of the present disclosure. In any embodiment, the controller receives outputs from the sensor element(s) and may utilize these outputs to determine if a stem is present and initiate operation of, for example, actuator(s) to close the cutting orifice around the detected stem and/or altering the speed of the rollers (e.g., increasing roller speed). In a further embodiment, the orifice may be reopened once the sensor output returns to a predetermined threshold. That is, the orifice may be reopened when the light intensity is re-established between the sensor elements 140 and/or the speed of the rollers may be returned to a baseline/idle speed.

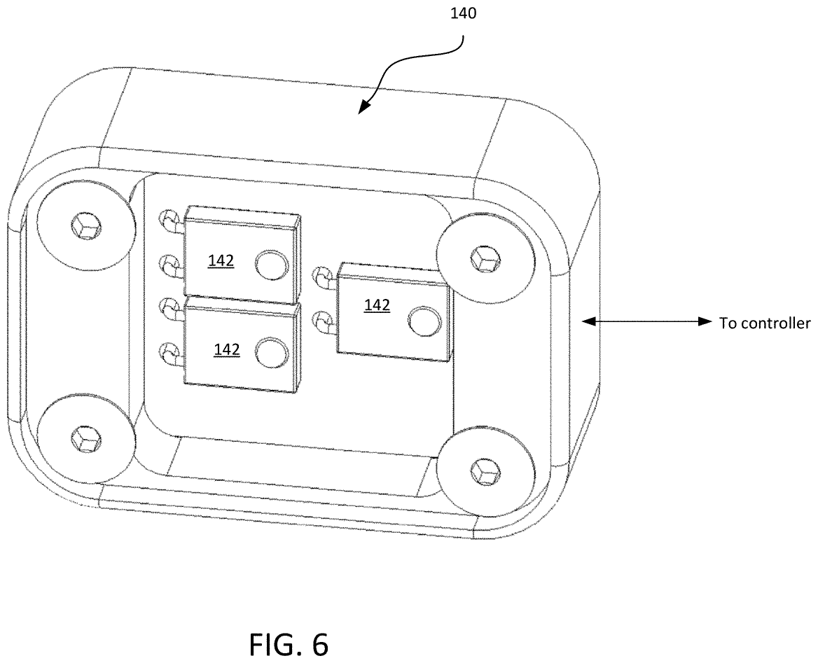

FIG. 6 illustrates one embodiment of the sensor 140. As shown, the sensor has three emitters or detectors 142 (i.e., depending on if the sensor is an emitting unit or a receiving unit). In such an embodiment, the sensor 140 may provide three separate light paths or beams across the front of the pinch nip between the rollers. The addition of multiple lights beams increases the likelihood of identifying a stem protruding through the cutting orifice. Further, the configuration of the three emitters or detectors provides good coverage along the surface of the mating rollers at the inlet nip. This is best illustrated in FIG. 7 which shows a partial side cross-sectional view of the sensor 140, the rollers 208, 210 and the iris mechanism 110. As shown, the utilization of a sensor 140 having multiple emitters and/or detectors 140 to project multiple lights across the pinch nip allows for identifying a plant stem even if it is not directly aligned with the crux of the pinch nip defined by the interface between the rollers. As will be appreciated, the system may be configured to close the cutting orifice upon any one of the multiple emitters/detectors identifying the presence of the stem. By way of example, the change in any of the detector elements caused by the blockage or partial blockage of any of the emitter elements may trip the system.

As illustrated in FIG. 7, the sensors 140 (only one illustrated) are disposed proximate to the pinch nip between the rollers 208 and 210. In this embodiment, the sensor is disposed behind a rearward surface of the iris mechanism 110. Stated otherwise, the sensor 140 is disposed between the drive rollers and the iris mechanism. However, it will be appreciated that a proximity sensor may be disposed in front of the iris mechanism as shown by the emitters/detectors 144 in phantom on the front surface of the iris mechanism. What is important is that the sensor(s) identify the presence of a stem passing through the orifice such that the orifice may be closed around the stem to allow stripping material from the stem as it is drawn between the rollers. Notably, it may be desirable to delay the closing of the cutting orifice of the iris mechanism for a predetermined time after sensing the presence of a plant stem. That is, delaying closure of the iris mechanism for such a predetermined time (e.g., a fraction of a second) may allow the plant stem to extend far enough into the device such that the plant stem is engaged between the counter rotating rollers prior to closing the iris mechanism around the stem. Such a delay may be based on the distance between the sensor and the drive rollers. For example, the delay may be less for a sensor that is disposed between the iris mechanism and the rollers than for a sensor that is disposed on the front surface of the iris mechanism.

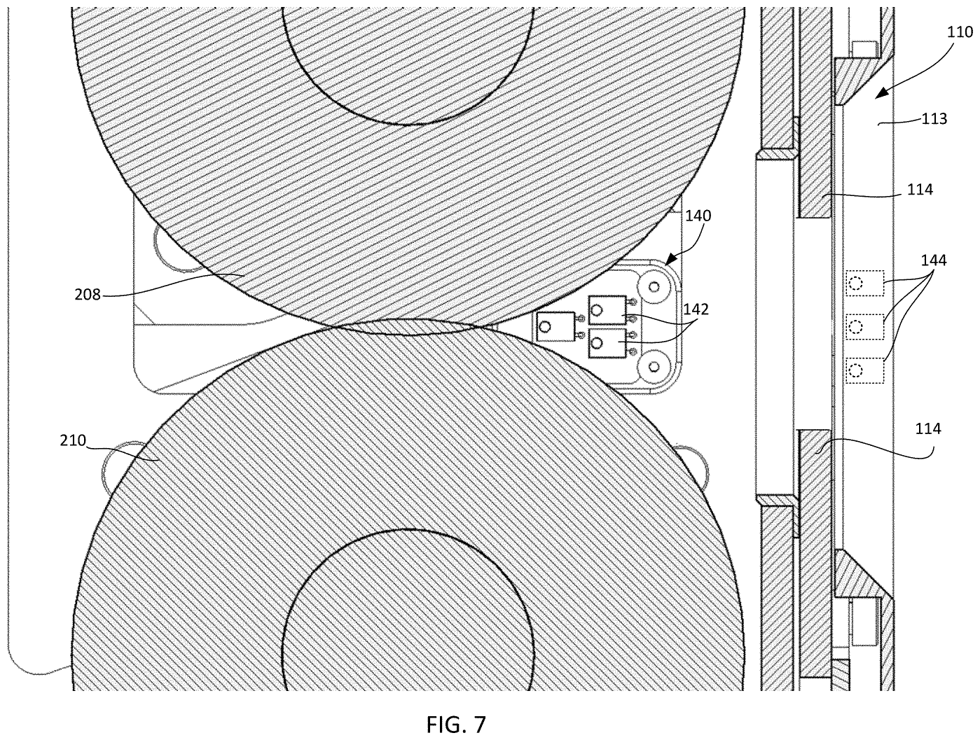

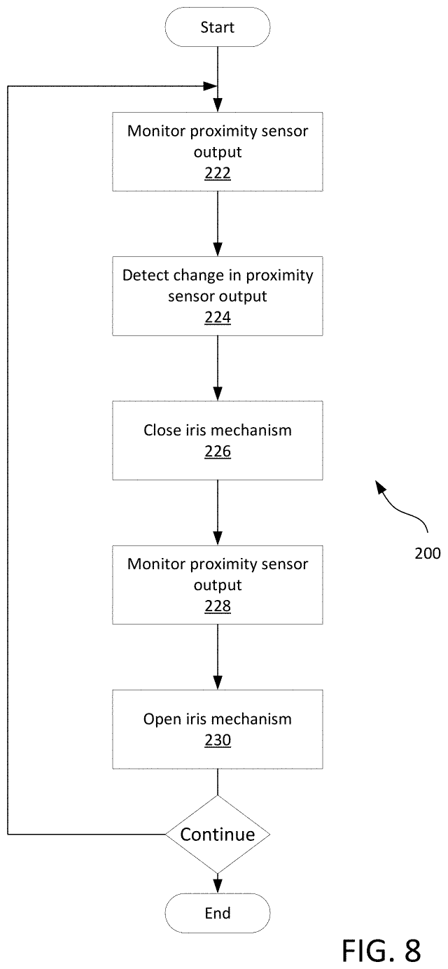

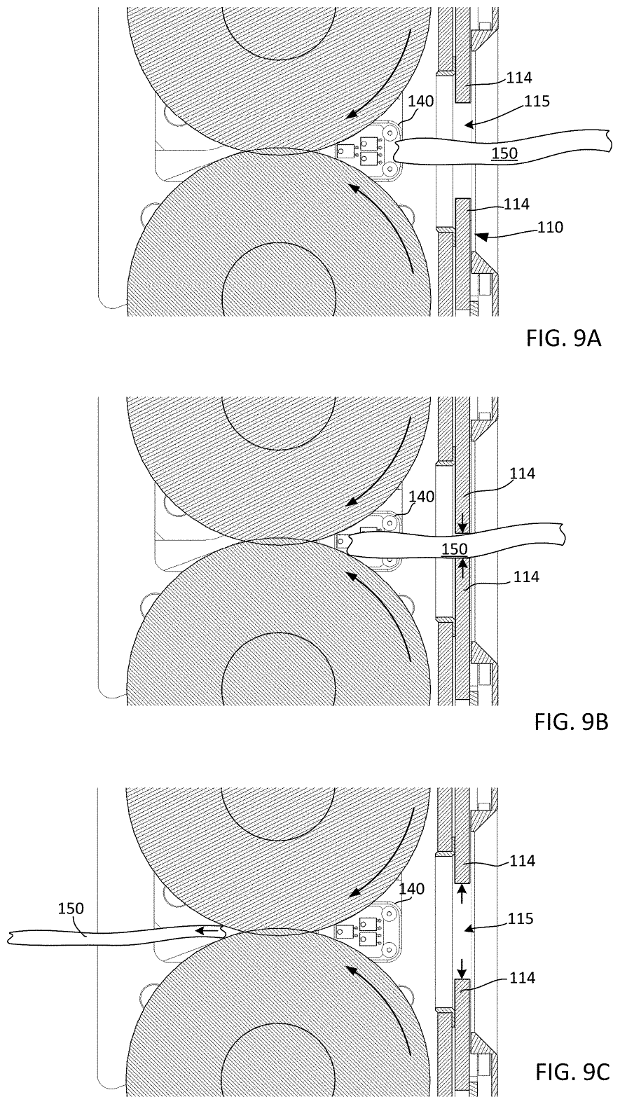

FIGS. 8 and 9A-9C illustrates a process 220 and method of operation of the device. The sensing and actuating portions of the process 220 may be incorporated as operating instructions or logic stored to non-transient storage media accessible by the controller. Initially, the process 220 includes monitoring 222 an output(s) of one or more proximity sensors. Such monitoring may include, for example, establishing a running average of the output of the proximity sensor or otherwise establishing a threshold for use in determining the presence of a plant stem. In conjunction with operation of the process 220, a user may insert a plant stem 150 through the open cutting orifice 115 defined by the blades 114 of the iris mechanism 110. See FIG. 9A. Once the stem 150 advances to a point that it interrupts or blocks at least one of the sensing elements of the proximity sensor 140, the process 220 may detect 224 a change in the sensor output. By way of example, an intensity output of the sensor(s) may be compared to a threshold intensity value and, upon being below or outside of the threshold value or range, the process 220 may generate a control output to close 226 the iris mechanism and/or increase roller speed. That is, the blades 114 of the iris mechanism may close around the stem 150 (see FIG. 9B) upon one of a sensing element(s) sensing the presence of the plant stem. As discussed above, such closure may be delayed a predetermined time to ensure that the end of the stem is engaged between the rollers 208, 210. The rollers may then draw the stem through the closed cutting orifice to strip plant material (not shown) from the plant stem. The process 220 may further include monitoring 228 the output(s) of a sensor(s) (e.g., the proximity sensor or a motor sensor) while the cutting orifice is closed. By way of example, when monitoring the proximity sensor 140, the process may entail comparing an intensity of the sensor to the threshold. After the plant stem passes through the rollers 208, 210, a pathway between the emitters/detectors of the sensor 140 is unblocked (e.g., exposed) and the intensity of the detector output may return to a level that is above or within the threshold value or range. Accordingly, the process 220 may include generating a control output to open 230 the iris mechanism and/or return the roller speed to a baseline/idle speed. See FIG. 9C. At this time, the harvesting device is ready to receive another stem. As will be appreciated, the process 220 of opening and closing the iris mechanism may be fully automated facilitating workflow as an operator need not manually close or open the iris mechanism.

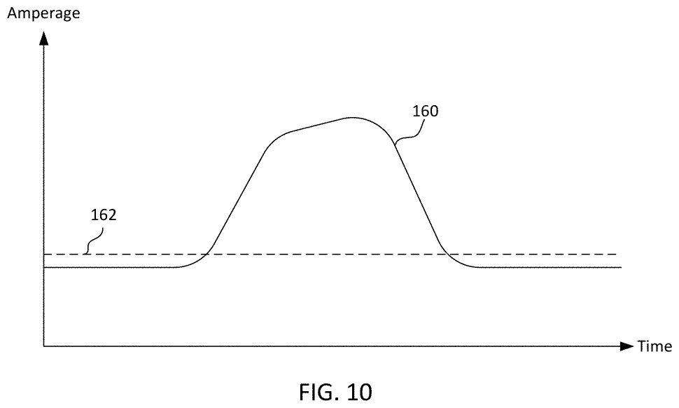

Though discussed above as utilizing the same sensor(s) to detect the presence and absence of a plant stem for purposes of opening and closing the iris mechanism, it will be appreciated that other arrangements are possible. In one alternate embodiment, a second sensing device or unit may monitor the operation of the drive motor to determine when a plant stem has completed passage through the device. As will be appreciated, when a stem is engaged between the rollers and the rollers are drawing a plant through the cutting orifice, one or more electrical parameters of the drive motor(s) changes. For instance, an amperage drawn by the motor(s) may change while the rollers are pulling the plant stem through the closed cutting orifice. Along these lines, a motor amperage may be monitored and compared to a known baseline amperage associated with operation of the motor free of plant material between the rollers. Once passage is complete, the controller may automatically open the cutting orifice. This is illustrated in a simplified graph shown in FIG. 10. As shown, when the motor(s) is turning the rollers in the absence of a load (e.g., pulling a plant stem through a closed cutting orifice) the amperage 160 may be a baseline level. Once the motor begins to pull the stem through the orifice, the amperage may increase until the stem completes passage through the rollers and the amperage drops back to or near the baseline level. One or more thresholds 162 may be established for determining when the plant has completed passage. Once the amperage falls below the threshold 162, the controller may reopen the cutting orifice. Other means of monitoring passage of the plant through the device are envisioned and considered within the scope of the present disclosure.

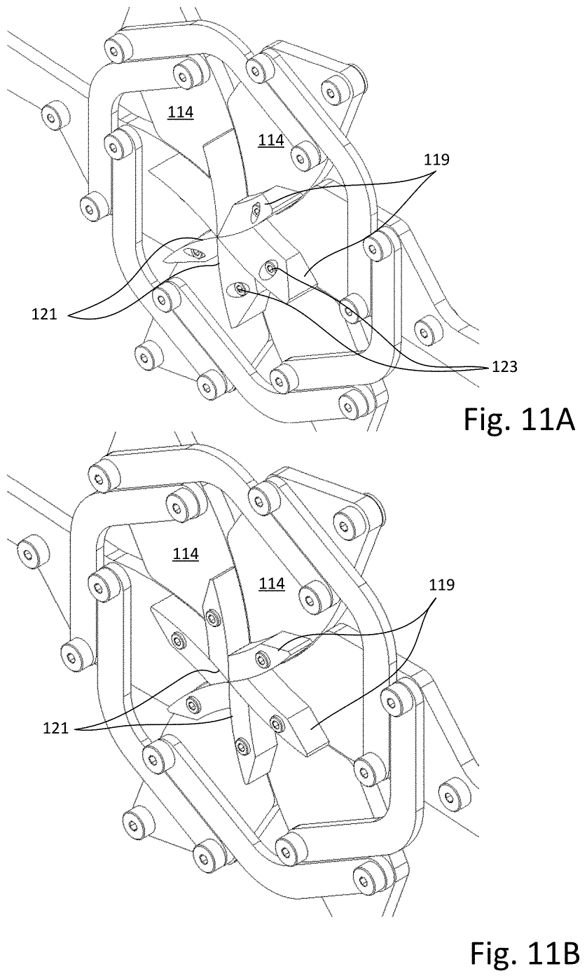

The presented iris mechanism may include another novel feature. Specifically, the blades 114 of the iris mechanism may utilize a separate blade insert 119. The blade inserts 119 may be attached to the cutting edge of each blade element 114. See FIGS. 11a and 11B. As shown the blade inserts 119 may be designed for use with different plants and/or for the same plants having different moisture levels. The blade inserts 119 may each include a cutting edge 121 that is utilized to strip material from a plant at the plant passes through the cutting orifice. Such blade inserts 119 may be attached to the underlying blade 114 utilizing one or more fasteners 123 (e.g., screws or bolts). Such fasteners may pass through a body of the blade insert 119 and connect to, for example, threaded apertures 127 disposed proximate to the cutting edge 111 of the underlying blade 114. See FIG. 3A. As will be appreciated, the blade inserts may be more readily replaced that the underlying blades, which are interconnected to move in unison. Accordingly, the use of the blade inserts greatly facilitates maintenance of the harvesting device. Specifically, the blade inserts may be readily replaced once they become dull or when different plants or plants having different moisture levels are processed.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A harvesting device for separating plant material from a stem and branches of a plant, comprising:
an iris mechanism including a plurality of blades, wherein the plurality of blades are movably connected to form an adjustable cutting orifice;
a drive mechanism including first and second rollers that interface to define a pinch nip configured to receive and engage a stem of a plant extending through the cutting orifice and pull the stem between the first and second rollers and through the cutting orifice;
a motor for rotating at least one of the first and second rollers; and
a first sensor configured to identify the presence of the stem disposed proximate to the cutting orifice when the cutting orifice is open and generate an output; and
an actuator configured to at least partially close the cutting orifice in response to the output from the sensor.

2. The harvesting device of claim 1, wherein an opening of the cutting orifice is disposed adjacent to the pinch nip of the first and second rollers.

3. The harvesting device of claim 1, wherein the first sensor is disposed between the pinch nip and a rear surface of the iris mechanism, wherein the stem of the plant is inserted through a front surface of the iris mechanism.

4. The harvesting device of claim 3, wherein the first sensor comprises a proximity sensor.

5. The harvesting device of claim 4, wherein the proximity sensor comprises at least one optical sensor.

6. The harvesting device of claim 5, wherein the optical sensor comprises:
a first sensor element disposed proximate to a first end of the first and second rollers, wherein the optical sensor emits a beam along the pinch nip between the first and second rollers.

7. The harvesting device of claim 6, wherein the optical sensor comprises:
a second sensor element disposed proximate to a second end of the first and second rollers configured to receive the beam from the first sensor element.

8. The harvesting device of claim 7, wherein the second element generates an output based on interruption of the beam received from the first sensor element.

9. The harvesting device of claim 6, wherein a plurality of sensor elements emit separate beams along the pinch nip between the first and second rollers.

10. The harvesting device of claim 1, wherein the first sensor is disposed on a front surface of the iris mechanism, wherein the stem of the plant is inserted through the front surface of the iris mechanism.

11. The harvesting device of claim 1, further comprising:
a second sensor configured to identify the absence of the stem when the cutting orifice is closed and generate an output, wherein the actuator configured to at least partially open the cutting orifice in response to the output from the second sensor.

12. The harvesting device of claim 11, wherein the first sensor and the second sensor are the same sensor.

13. The harvesting device of claim 11, wherein the second sensor monitors at least a first electrical parameter of the motor.

14. The harvesting device of claim 1, further comprising:
a controller configured to receive the output from the first sensor and control opening or closing of the actuator.

15. The harvesting device of claim 14, wherein the controller is further configured to control a speed of the motor based on the output of the first sensor.

16. A method for removing plant material from a plant, comprising:
sensing a presence of a plant stem disposed proximate to an open cutting orifice of an iris mechanism having a plurality of blades;
upon sensing the plant stem, closing the cutting orifice such that the plurality blades contact an outer surface of the plant stem;
engaging the plant stem between first and second counter rotating rollers in conjunction with closing the cutting orifice;
pulling the plant stem through the cutting orifice to remove plant material from the stem.

17. The method of claim 16, further comprising:
sensing the absence of the stem when the cutting orifice is closed; and
opening the cutting orifice.

18. The method of claim 16, further comprising:
delaying the closing the cutting orifice for a predetermined time after the sensing of the plant stem.

19. The method of claim 16, wherein sensing the presence of the plant stem comprises:
sensing the plant stem at a location proximate to a pinch nip between the first and second counter rotating rollers.

20. The method of claim 17, wherein the sensing of the presence of the plant stem comprises obtaining an output from a proximity sensor.
